(19) United States
(12) Patent Application Publication
(10) Pub. No.: US 2023/0246457 A1
(43) Pub. Date: Aug. 3, 2023

(54) DEVICE, METHOD, PROGRAM, AND SYSTEM FOR INTEGRATED CHARGING

(71) Applicant: BRONINE CO., LTD., Seoul (KR)

(72) Inventor: Sunhwi MYUNG, Seoul (KR)

(73) Assignee: BRONINE CO., LTD., Seoul (KR)

(21) Appl. No.: 17/587,705

(22) Filed: Jan. 28, 2022

(30) Foreign Application Priority Data
Jan. 28, 2022 (KR) 10-2022-0013000

(51) Int. Cl. H02J 7/00

(52) U.S. Cl. CPC H02J 7/00047; H02J 7/0013; H02J 7/00036; H02J 7/0048; H02J 7/00712; H02J 7/007194; H02J 2207/20

(57) ABSTRACT

A system for integrated charging is provided. The system for integrated charging includes a charging device capable of charging battery devices, each of which has a different charging specification.

### CROSS-REFERENCE TO RELATED APPLICATIONS

The present application is based upon and claims the benefit of priority to Korean Patent Application No. 10-2022-0013000, filed on Jan. 28, 2022 to the Korean Intellectual Property Office, the entire contents of which are hereby incorporated by reference.

### BACKGROUND

Embodiments of the inventive concept described herein relate to a device for integrated charging, and more particularly, relate to a device for integrated charging for directly controlling charging of a battery depending to the amount of charge of the battery.

An adapter is a device which uniformly supplies a predetermined voltage and current to an electronic device, which is a kind of a constant power supply device. There are various types of adapters, but the adapter is currently standardized in a manner capable of performing power delivery (PD) charging for fast charging in a USB-B type standard terminal.

In contrast, there is no standardization of a charging device which directly controls charging of the battery depending on the amount of charge of the battery.

In detail, a shape of the battery, a terminal of the battery, and a voltage and current for charging the battery are often different. Thus, different charging devices are used according to a type of the battery or a type of an electronic device which uses the battery. Due to this, an enterprise should produce and sell a dedicated charging device whenever producing an electronic device and a consumer should purchase the electronic device and the dedicated charging device together.

In addition, when the consumer does not use a corresponding electronic device any longer, the charging device for only the specific electronic device becomes garbage.

Thus, standardization of charging devices is also urgently needed. There is a need for a technology capable of charging various batteries in an integrated manner, but such a technology is not currently disclosed to the public.

### SUMMARY

Embodiments of the inventive concept provide a system for integrated charging including a charging device capable of charging battery devices, each of which has a different charging specification.

Embodiments of the inventive concept may be to receive information about a rated voltage and a rated current of a battery cell from a circuit module in a battery device, when connected with the battery device, and determine a charging specification range and a charging type of the battery device based on the received information.

Embodiments of the inventive concept may be to determine whether to supply constant power or charging power based on the result of communicating with a power supply target device, when connected with the power supply target device, and may control a conversion unit depending on the determined result to supply voltage.

The technical problems to be solved by the inventive concept are not limited to the aforementioned problems, and any other technical problems not mentioned herein will be clearly understood from the following description by those skilled in the art to which the inventive concept pertains.

According to an embodiment, a system for integrated charging may include a charging device and a battery device. The battery device may include a battery cell, a first memory that stores charging specification information about charging power required in the battery cell, and a first input/output terminal. The charging device may include a power supply unit that receives power, at least one second input/output terminal connected with the battery device, a conversion unit that converts the power into an output corresponding to the charging specification information, and a controller that receives the charging specification information through the at least one second input/output terminal, when connected with the battery device, controls to convert the power, based on the received charging specification information, and controls such that the converted output is supplied to the battery device through the at least one second input/output terminal.

The charging device may be a charging control entity of the battery cell. The battery device may further include a monitoring unit that monitors information about a state of charge of the battery cell through the at least one second input/output terminal, while the converted output is supplied to the battery device. The battery cell may adjust a charging specification for the battery device based on the result of monitoring the information about the state of charge.

The battery device may further include a communication negotiation chip for communication between the battery device and the charging device. The first memory, the communication negotiation chip, and the first input/output terminal may make up a standardization module.

Each of the first input/output terminal and the second input/output terminal may be a USB-C type terminal.

A removable battery and an embedded battery in an electronic device are applicable to the battery device. The charging device may convert and supply first power into second power based on the charging specification information, such that it is possible to supply power to the battery device which does not have a transformation function.

According to an embodiment, a system for integrated charging may include a power supply unit that receives first power, at least one type of input/output terminal connected with a power supply target device, a conversion unit that converts the first power into second power for being supplied to the power supply target device, and a charging device controller that determines whether to supply constant power or charging power to the power supply target device based on the result of communicating with the power supply target device and controls the conversion unit depending on the determined result, when the power supply target device is connected with the at least one type of input/output terminal. The charging device controller may receive charging specification information from a first memory included in a battery device in the power supply target device, when it is determined to supply the charging power to the power supply target device, may determine second power for being supplied to the battery device based on the received charging specification information, may control the conversion unit to convert the first power into the determined second power, may determine the second power for the power supply target device based on the result of negotiations with the power supply target device, when it is determined to supply the constant power to the power supply target device, and may control to supply the constant power to the power supply target device using the determined second power.

The controller may determine a charging specification range of a battery and a charging type including fast charging or normal charging based on the result of communicating with the power supply target device and may control the conversion unit based on the determined charging specification range and the determined charging type, when the power supply target device is the battery device.

The controller may monitor information about a state of charge of the battery device during a predetermined time after supplying charging power to the battery device and may adjust a specification of the second power based on the result of monitoring the information about the state of charge.

The controller may operate a monitoring unit and may determine a monitoring level for the battery device, based on a specification of the determined second power, when the power supply target device is the battery device.

The controller may monitor information about a state of charge of the power supply target device during a predetermined time after supplying charging power to the power supply target device, may compare the information about the state of charge with the result of communicating with the power supply target device to determine a current battery specification of the power supply target device, and may adjust a charging specification for the power supply target device based on the determined current battery specification.

The controller may determine any one of the power supply target device and a charging device as a charging control entity of the power supply target device based on at least one of performance of a processor of the power supply target device and information about a state of charge, after supplying the constant power to the power supply target device.

The controller may determine the charging device as a charging control entity of a battery cell included in the power supply target device, when a temperature of the battery cell is greater than or equal to a predetermined temperature based on a monitored result.

In addition, another method for implementing the inventive concept, another system therefor, and a computer-readable storage medium storing a computer program for executing the method may be further provided.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram of a device for integrated charging according to an embodiment of the inventive concept;

FIG. 2 illustrates a charging specification table which stores output information supported in a device for integrated charging according to an embodiment of the inventive concept;

FIGS. 3 and 4 are block diagrams of a system for integrated charging according to an embodiment of the inventive concept;

FIG. 5 is a drawing illustrating a first input/output terminal;

FIG. 6 is a flowchart of a method for integrated charging according to an embodiment of the inventive concept;

FIG. 7 is a drawing illustrating an effect of a system for integrated charging according to an embodiment of the inventive concept;

FIG. 8 is a block diagram of a device for integrated charging according to another embodiment of the inventive concept;

FIG. 9 is a block diagram of a system for integrated charging according to another embodiment of the inventive concept;

FIG. 10 is a flowchart when supplying constant power in a method for integrated charging according to an embodiment of the inventive concept; and

FIG. 11 is a flowchart when supplying charging power in a method for integrated charging according to an embodiment of the inventive concept.

### DETAILED DESCRIPTION

Advantages, features, and methods of accomplishing the same in the inventive concept will become apparent with reference to embodiments described in detail below together with the accompanying drawings. The inventive concept, however, may be embodied in various different forms, and should not be construed as being limited only to the illustrated embodiments. Rather, these embodiments are provided as examples so that the inventive concept will be thorough and complete, and will fully convey the scope of the inventive concept to those skilled in the art. The inventive concept may be defined by the scope of the claims.

The terms used herein are provided to describe embodiments, not intended to limit the inventive concept. In the specification, the singular forms include plural forms unless particularly mentioned. The expressions “comprise” and/or “comprising” used herein indicate existence of one or more other elements other than stated elements but do not exclude presence of additional elements. Like reference numerals designate like elements throughout the specification, and the term “and/or” may include each of stated elements and one or more combinations of the stated elements. The terms such as “first” and “second” are used to describe various elements, but it is obvious that such elements are not restricted to the above terms. The above terms are used only to distinguish one element from the other. Thus, it is obvious that a first element described hereinafter may be a second element within the technical scope of the inventive concept.

Unless otherwise defined, all terms (including technical and scientific terms) used herein have the same meaning as commonly understood by those skilled in the art to which the inventive concept pertains. Also, terms which are defined in a dictionary and commonly used should be interpreted as not in an idealized or overly formal detect unless expressly so defined.

Hereinafter, an embodiment of the inventive concept will be described in detail with reference to the accompanying drawings.

A charging device may directly control charging of a battery device depending on the amount of charge of the battery device. An adapter may be a constant power supply device, which may uniformly supply a predetermined voltage and a predetermined current to an electronic device. When the adapter is used to charge the battery device in the electronic device, a charging module in the electronic device may be responsible for charging of the battery device. Thus, the charging device and the adapter may have a difference in who is responsible for controlling the charging of the battery device.

Integration in a device for integrated charging may have a double meaning according an embodiment. One is integration of a meaning that it is possible to charge various battery devices, and the other is integration of a meaning that it is possible to perform both of functions of the charging device and the adapter.

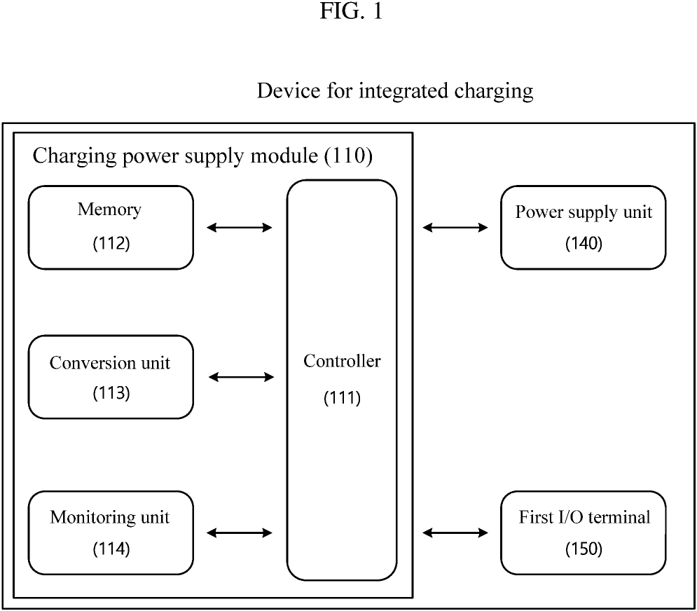

First of all, a description will be given of a device 100 for integrated charging, which is capable of charging various battery devices with reference to FIGS. 1 to 7.

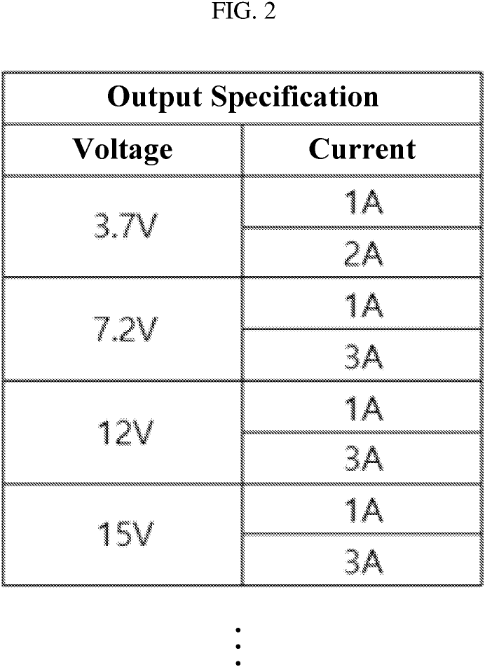

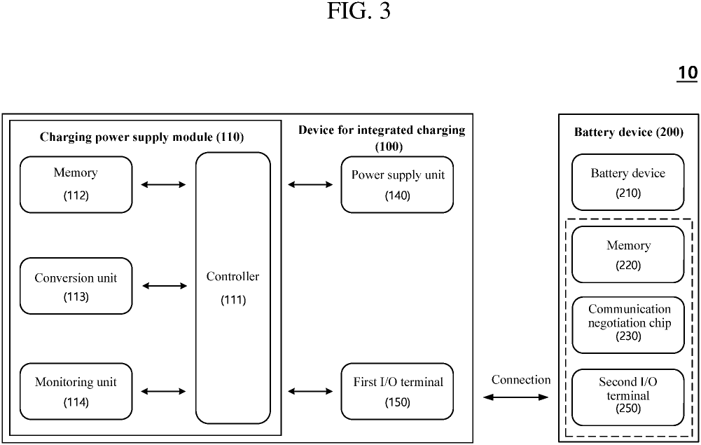

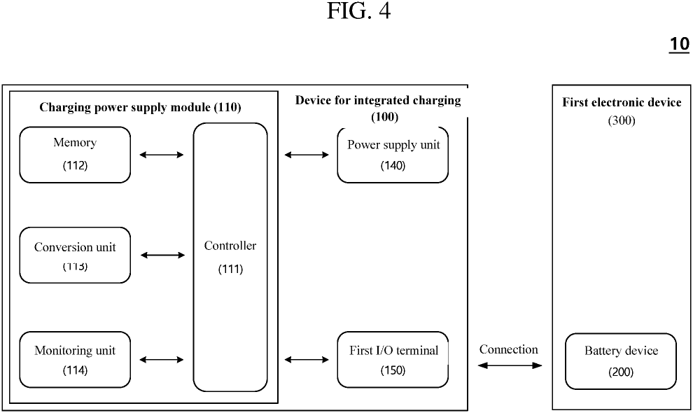

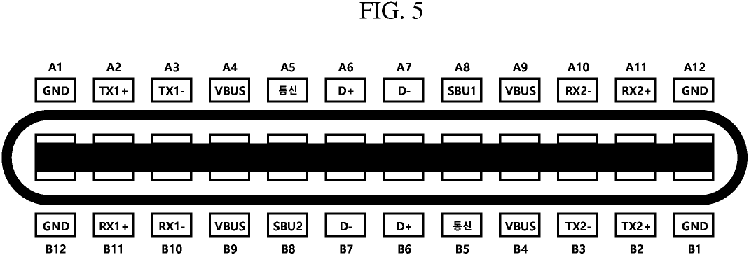

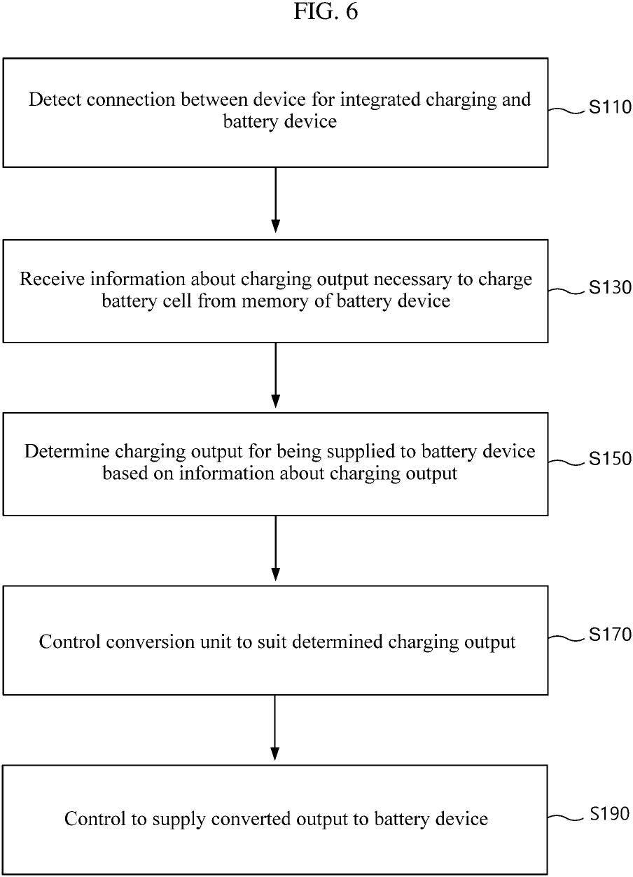

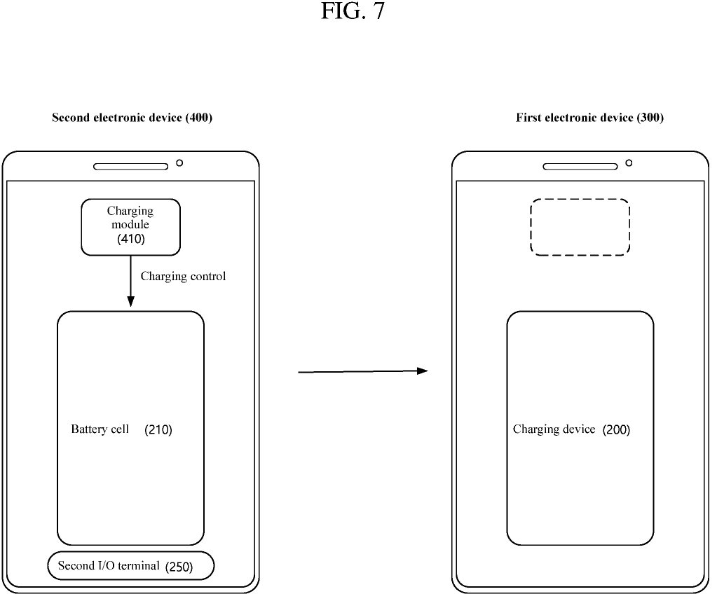

FIG. 1 is a block diagram of a device for integrated charging according to an embodiment of the inventive concept. FIG. 2 illustrates a charging specification table which stores output information supported in a device for integrated charging according to an embodiment of the inventive concept. FIGS. 3 and 4 are block diagrams of a system for integrated charging according to an embodiment of the inventive concept. FIG. 5 is a drawing illustrating a first input/output terminal. FIG. 6 is a flowchart of a method for integrated charging according to an embodiment of the inventive concept. FIG. 7 is a drawing illustrating an effect of a system for integrated charging according to an embodiment of the inventive concept.

A system 10 for integrated charging may include a device 100 for integrated charging and a battery device 200.

The device 100 for integrated charging may include a charging power supply module 110, a power supply unit 140, and a first input/output terminal 150. The charging power supply module 110 may include a controller 111, a memory 112, a conversion unit 113, and a monitoring unit 114. However, in some embodiments, the device 100 for integrated charging may include less or more components than the components shown in FIG. 1.

The power supply unit 140 may receive power.

In detail, as a plug terminal is inserted into an outlet, the power supply unit 140 may receive commercial power. However, the scheme where the power supply unit 140 receives power is not limited to the input of commercial power, and power may be supplied in various schemes such as AC power, DC power, power by an auxiliary battery, and the like.

In this case, because power the device 100 for integrated charging receives through the power supply unit 140 is not yet power of a level suitable for the battery device 200 or a first electronic device 300, it may need transformation.

Meanwhile, the power supply unit 140 may include, but is not limited to, for example, an AC outlet, a front rectifier circuit, a front filter circuit, an AC/DC conversion control circuit, an output feedback circuit, an isolation transformer, a synchronous rectification output circuit, or the like.

As shown in FIG. 2, the memory 112 may store a charging specification table which stores output information supportable by the device 100 for integrated charging. However, the voltage/current shown in FIG. 2 is merely illustrative, and the output supportable by the device 100 for integrated charging is not limited thereto.

The charging specification table stored in the memory 112 may be present for standardization of a charging device. Because the device 100 for integrated charging according to an embodiment of the inventive concept provides a charging output according to the charging specification table, an enterprise which produces and sells the battery device 200 or the first electronic device 300 may store information about an output suitable for the battery device 200 or the first electronic device 300 among outputs supported by the device 100 for integrated charging in a memory 220 of the battery device 200 or the first electronic device 300 and may sell the battery device 200 or the first electronic device 300, without the necessity of separately manufacturing a charging device.

Furthermore, the memory 112 may store various instructions and algorithms for executing the system 10 for integrated charging. In some embodiments, the memory 112 may store a learned and constructed artificial intelligence model.

The memory 112 of the device 100 for integrated charging may be referred to as a first memory to be distinguish from the memory 220 of the battery device 200, and the memory 220 of the battery device 200 may be referred to as a second memory.

The conversion unit 113 may control transformation to suit a specification of the battery device 200 or the first electronic device 300. For example, the conversion unit 113 may control an output (a voltage or current) of the device 100 for integrated charging to suit a rated voltage or a rated current for the battery device 200 or the first electronic device 300 or may control an output of the device 100 for integrated charging to suit the input signal.

In an embodiment of the inventive concept, the conversion unit 113 may include components such as a transformer and a constant voltage unit, and the controller 111 may execute a function of each component. For example, the conversion unit 113 may include, but is not limited to, a buck boost circuit.

In detail, the conversion unit 113 may perform transformation to a corresponding voltage depending on charging power and may perform transformation to correspond to an output magnitude determined for the battery device 200 or the first electronic device 300.

The monitoring unit 114 may monitor various pieces of information which need monitoring.

After supplying power to the battery device 200, the monitoring unit 114 may monitor information about a state of charge (or information about the amount of charge) of the battery device 200 based on the result of communication between the device 100 for integrated charging and the battery device 200.

For example, the monitoring unit 114 may obtain information about a state of charge of the battery device 200 for each predetermined time. The controller 111 may analyze the information about the state of charge of the battery to change a charging condition (or an output) of the battery or stop charging the battery.

In other words, in the system 100 for integrated charging according to an embodiment of the inventive concept, because the monitoring unit 114 is able to obtain information about a state of charge of the battery device 200 or the battery device 200 in the first electronic device 300, the device 100 for integrated charging may control charging of the battery device 200 depending on the amount of charge of the battery device 200.

At least one first input/output terminal 150 may be included in the device 100 for integrated charging and may be connected with the battery device 200. In detail, the first input/output terminal 150 may be connected with a second input/output terminal 250 of the battery device 200. The device 100 for integrated charging may provide the battery device 200 with an output for charging through the first input/output terminal 150 and may communicate with the battery device 200 using the first input/output terminal 150.

For example, the first input/output terminal 150 may be formed in a USB-C type. Referring to FIG. 5, VBUS (pin numbers A4, A9, B4, and B9) may be used to supply power to the connected battery device 200 and pin numbers A5 and B5 may be used for communication between the device 100 for integrated charging and the battery device 200, but not limited thereto.

In an embodiment of the inventive concept, it is exemplified that the first input/output terminal 150 and the second input/output terminal 250 are formed in the USB-C type, but not limited thereto. Each of the first input/output terminal 150 and the second input/output terminal 250 may be any one of a USB-C type terminal, a micro 5-pin terminal, or a lightning 8-pin terminal and may be any terminal when it is possible to supply power and communicate.

The controller 111 may be responsible for control of components in the device 100 for integrated charging and may execute a method for integrated charging by executing various instructions and algorithms stored in the memory 112.

Meanwhile, to obtain information about a charging output suitable for the battery device 200 or the first electronic device 300, the controller 111 may transmit a microcurrent from the device 100 for integrated charging to the battery device 200 or the first electronic device 300 and may receive information about an output (a voltage or current) suitable for the battery device 200, which is stored in the memory 220 of the battery device 200 or the first electronic device 300, thus identifying a rated voltage or the like for the battery device 200 or the first electronic device 300.

Referring to FIG. 3, the battery device 200 may include a battery cell 210, the memory 220, a communication negotiation chip 230, and the second input/output terminal 250. Herein, the battery device 200 may be, but is not limited to, a removable battery. The battery device 200 included in the first electronic device 300 may be an embedded battery.

However, in some embodiments, the battery device 200 may include less or more components than the components shown in FIGS. 1 and 2.

Information about a charging output may be stored in the memory 220 of the battery device 200. For example, information of at least one of a rated voltage or a rated current may be included in the memory 220 of the battery device 200. For example, the information about the charging output, which is stored in the memory 220 of the battery device 200, may be information about any one of charging specification tables stored in the memory 112 of the device 100 for integrated charging. Thus, the system 10 for integrated charging according to an embodiment of the inventive concept may be standardized.

In detail, the first memory 112 of the device 100 for integrated charging may store a charging specification table which stores pieces of information of various batteries, and the memory 220 of the battery device 200 may store only information about a charging specification of the battery cell 210.

The communication negotiation chip 230 may be a component for communication between the battery device 200 and the device 100 for integrated charging.

The second input/output terminal 250 may be connected with the device 100 for integrated charging. For example, the second input/output terminal 250 may be formed in the USB-C type, but not limited thereto.

In an embodiment of the inventive concept, it is exemplified that each of the first input/output terminal 150 and the second input/output terminal 250 is formed in the USB-C type, but not limited thereto. Each of the first input/output terminal 150 and the second input/output terminal 250 may be any one of a USB-C type terminal, a micro 5-pin terminal, or a lightning 8-pin terminal and may be any terminal when it is possible to supply power and communicate.

The battery device 200 according to an embodiment of the inventive concept may communicate with the device 100 for integrated charging using the communication negotiation chip 230 and the standardized second input/output terminal 250. The charging output stored in the memory 220 of the battery device 200 may be a charging output supported by the device 100 for integrated charging. Thus, it is possible to charge the battery device 200 or the first electronic device 300 according to an embodiment of the inventive concept using the device 100 for integrated charging.

In other words, an enterprise which manufactures the battery device 200 or the first electronic device 300 may easily transform the battery device 200 or the first electronic device 300 of the enterprise into a product which uses the standardized device 100 for integrated charging, by means of a simple manner which applies a standardization module including the memory 220, the communication negotiation chip 230, and the second input/output terminal 250 to the battery device 200 or the first electronic device 300. In some embodiments, the memory 220, the communication negotiation chip 230, and the second input/output terminal 250 may be integrated into one hardware to be formed as a standardization module.

Hereinafter, a description will be given in detail of a method for integrated charging according to an embodiment by the system 10 for integrated charging with reference to FIG. 6.

First of all, in operation S110, the controller 111 may detect a connection between the device 100 for integrated charging and the battery device 200.

In detail, the controller 111 may detect that the first input/output terminal 150 of the device 100 for integrated charging and the second input/output terminal 250 of the battery device 200 or the first electronic device 300 are connected with each other.

In operation S130, the controller 111 may receive information about a charging output necessary to charge the battery cell 210 from the memory 220 of the battery device 200.

As described above, the controller 111 may transmit a microcurrent to the battery device 200 or the first electronic device 300 and may receive information about an output (a voltage or current) suitable for the battery device 200, which is stored in the memory 220 of the battery device 200 or the first electronic device 300, thus identifying a rated voltage or the like for the battery device 200 or the first electronic device 300.

In operation S150, the controller 111 may determine a charging output for being supplied to the battery device 200 based on the information about the charging output, which is received in operation S130.

In operation S170, the controller 111 may control the conversion unit 113 to transform an output of the device 100 for integrated charging to suit the determined charging output.

In operation S190, the controller 111 may control the conversion unit 113 such that power is supplied according to a charging specification range and a charging type.

Like operation S110, as soon as the connection between the device 100 for integrated charging and the battery device 200 is detected, the controller 111 may first receive charging specification information of the battery cell 210 from the memory 220 of the battery device 200.

The controller 111 may determine a specification of an output for being supplied to the battery device 200, based on the charging specification information of the battery cell 210.

The controller 111 may convert power supplied from the power supply unit 140 to supply power depending on the determined specification of the output.

In an embodiment of the inventive concept, the charging specification information may include a value or a range of an input voltage, an input current, or the like of the battery device 200, and the specification of the output may include a value or a range of an output voltage, an output current, or the like.

A description will be given of an effect of the system 10 for integrated charging according to an embodiment of the inventive concept with reference to FIG. 7. A second electronic device 400 may be a device which is charged by receiving constant power (e.g., based on PD charging or the like) through an adapter. The battery cell 210 may be embedded in the second electronic device 400. For example, the second electronic device 400 may be a smartphone, a tablet, a laptop, or the like.

The adapter does not monitor a state of charge of the battery cell 210 or an amount of charge of the battery cell 210 and may be a constant power supply device to uniformly and only provide a predetermined voltage and current to the second electronic device 400. Thus, the second electronic device 400 may include a charging module 410 for controlling stable charging of the battery cell 210. The charging module 410 may include a component for monitoring a state of charge of the battery cell 210 or an amount of charge of the battery cell 210 and protecting overdischarge or overcurrent of the battery cell 210, or the like.

Because the charging module 410 itself occupies a space, it may be a burden on the second electronic device 400 which aims to become smaller. In addition, heating may occur from the charging module 410 in the process of charging the second electronic device 400.

When selecting a charging scheme by the device 100 for integrated charging like the first electronic device 300 without selecting a charging scheme by the adapter like the second electronic device 400, the electronic device has the following advantages.

First of all, because the charging module 410 is not needed in the electronic device any longer, the electronic device may be miniaturized by the space occupied by the charging module 410 and the cost of the electronic device may be saved. Furthermore, heating occurring from the charging module 410 may be fundamentally removed.

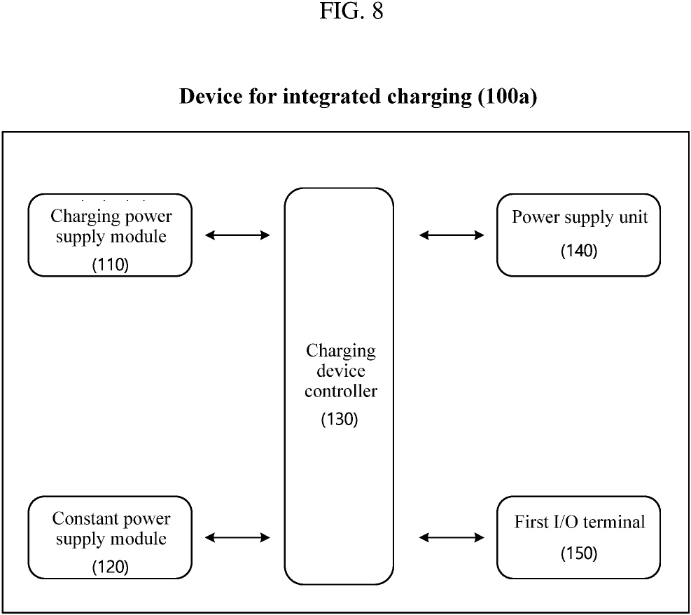

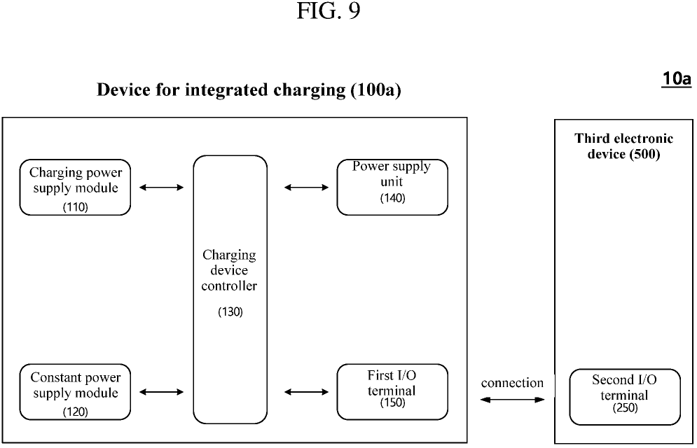

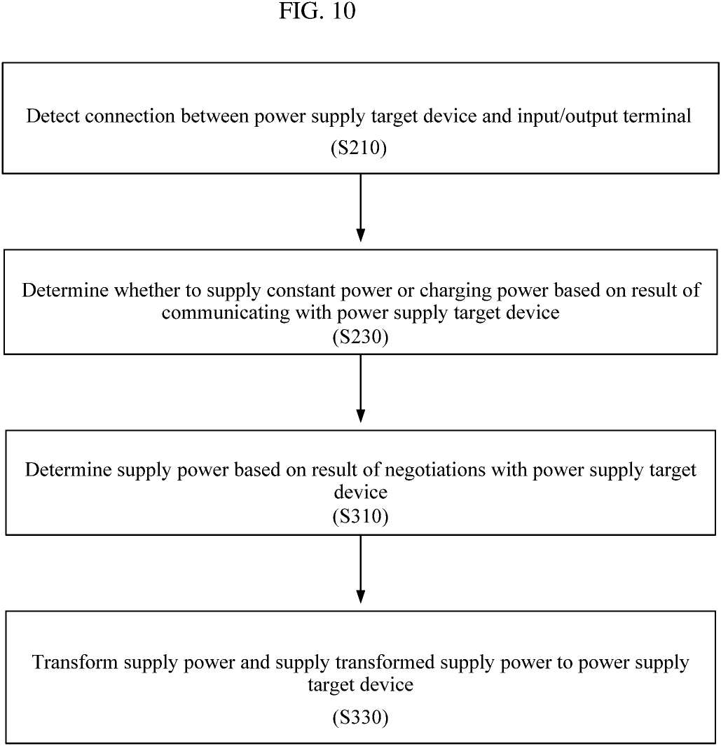

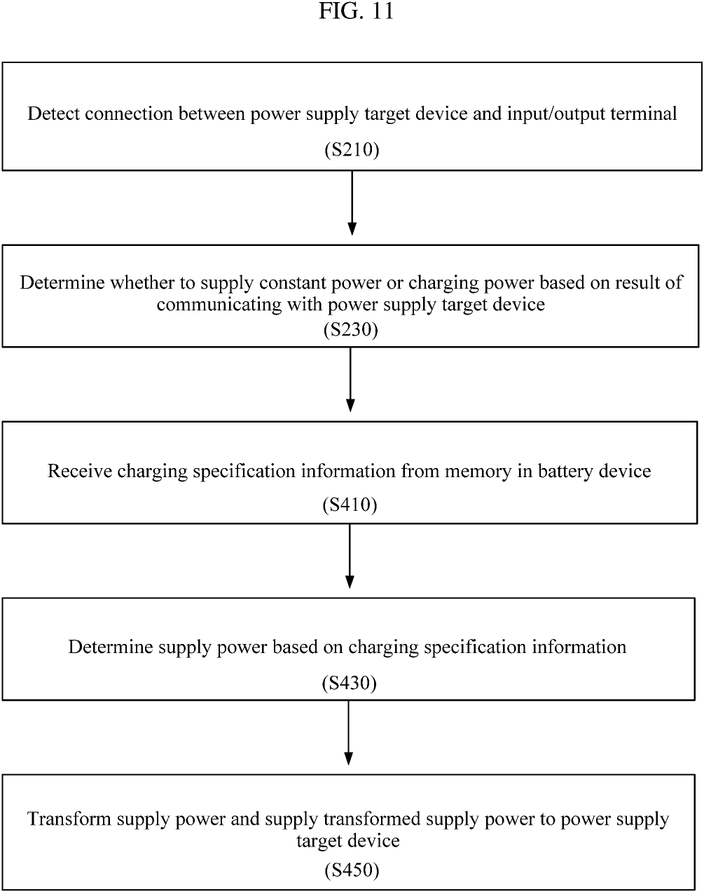

Hereinafter, a description will be given of a device 100a for integrated charging, which is capable of performing both of functions of the charging device and the adapter with reference to FIGS. 8 to 11. FIG. 8 is a block diagram of a device for integrated charging according to another embodiment of the inventive concept. FIG. 9 is a block diagram of a system for integrated charging according to another embodiment of the inventive concept. FIG. 10 is a flowchart when supplying constant power in a method for integrated charging according to an embodiment of the inventive concept. FIG. 11 is a flowchart when supplying charging power in a method for integrated charging according to an embodiment of the inventive concept. However, a description will be given of a difference with a device 100 for integrated charging, which is capable of charging various battery devices.

Referring to FIG. 8, a device 100a for integrated charging may include a charging power supply module 110, a constant power supply module 120, a charging device controller 130, a power supply unit 140, and a first input/output terminal 150.

Because the device 100a for integrated charging includes both the charging power supply module 110 for performing a charging device function and the constant power supply module 120 for performing an adapter function, it may perform both the charging device function and the adapter function.

In other words, as well as a battery device 200 and a first electronic device 300 which receive charging power, a second electronic device 400 and a third electronic device 500 which receive constant power may receive power by the device 100a for integrated charging.

For example, the battery device 200 associated with a removable battery, the first electronic device 300 which includes a removable battery or an embedded battery and does not assist in supplying constant power, the second electronic device 400 which assists in supplying constant power (PD charging) and includes an embedded battery, the third electronic device 500 (e.g., a monitor, a TV, or the like) which needs to supply constant power without a battery, or the like may be applied.

When it is needed to include an embedded battery or a removable battery and simultaneously supply constant power like a smartphone or a tablet PC, an implementer of the inventive concept may easily select it.

The device 100a for integrated charging may have the single first input/output terminal 150. When the battery device 200 having a second input/output terminal 250 corresponding to the first input/output terminal 150, the first electronic device 300, the second electronic device 400 or the third electronic device 500 is connected with the first input/output terminal 150, the device 100a for integrated charging may operate the charging power supply module 110 or the constant power supply module 120 to suit a device connected after the charging device controller 130 identifies a signal input to the device 100a for integrated charging, thus supplying necessary power to the device.

Thus, according to the device 100a for integrated charging according to an embodiment of the inventive concept, when a user only connects the battery device 200 or the electronic device 300, 400, or 500 with the first input/output terminal 150 without regard to properties of the battery device 200 or the electronic device 300, 400, or 500, power suitable for the battery device 200 or the electronic device 300, 400, or 500 may be supplied to conveniently charge the battery device 200.

As an embodiment, when charging specification information received from a memory 220 of the battery device 200 is input, the charging device controller 130 may supply charging power to the battery device 200 based on the charging specification information using the charging power supply module 110. A monitoring unit 114 of the charging power supply module 110 may monitor information about a state of charge of the battery device 200 based on the result of communicating with the battery device 200.

A controller 111 may adjust a specification of charging power supplied to the battery device 200 based on the result of monitoring the information about the state of charge.

When the device 100a for integrated charging and the battery device 200 are connected with each other, the controller 111 may communicate with the battery device 200 continuously or for each predetermined time.

In detail, the controller 111 may control the monitoring unit 114 to monitor the battery device 200. The monitoring unit 114 may obtain information about at least one of a battery charging speed according to power supply, a battery charging efficiency according to power supply, a battery capacity according to power supply, or a temperature of the battery cell 210 during charging.

The controller 111 may generate information about a state of charge using the at least obtained one of the battery charging speed, the battery charging efficiency, the battery capacity, or the temperature of the battery cell 210 during charging.

The information about the state of charge may schematically refer to efficiency where power is charged in the battery according to a power input.

Meanwhile, the constant power supply module 120 may record information about supplied constant power (at least one of voltage or current) and a constant power supply accumulation time in a memory (not shown).

When the device 100a for integrated charging and the second electronic device 400 are connected with each other, the constant power supply module 120 may recognize the information about the supplied constant power and the constant power supply accumulation time and may determine a charging specification range of the battery cell 210 of the second electronic device 400 based on the recognized result.

As an embodiment, the constant power supply module 120 may recognize the information about the supplied constant power and the constant power supply accumulation time and may match the recognized result with a charging specification table stored in the memory (not shown) to determine a charging specification of the battery cell 210 of the second electronic device 400.

In this case, the charging specification of the battery cell 210 of the second electronic device 400 may include a range of an output current or an output voltage for being supplied to the battery cell 210.

As an embodiment, the device 100a for integrated charging may control a conversion unit 113 such that power is supplied according to the determined charging specification, thus supplying voltage to the first electronic device 300 which does not include a charging module 410.

As an embodiment, the controller 111 may adjust a specification of charging power for the battery device 200 based on the result of monitoring the information about the state of charge.

As an embodiment, when constant power is supplied by the constant power supply module 120 as the second electronic device 400 is connected with the device 100a for integrated charging, a charging device controller 130 may periodically receive information about a temperature of the battery cell 210 from the second electronic device 400. In this case, when the temperature of the battery cell 210 of the second electronic device 400 is greater than or equal to a predetermined temperature based on the monitored result, the charging device controller 130 may operate the charging power supply module 110 rather than the constant power supply module 120 to supply charging power to the battery cell 210 of the second electronic device 400.

In other words, when the temperature of the battery cell 210 of the second electronic device 400 is greater than or equal to the predetermined temperature based on the monitored result, the charging device controller 130 may determine that the charging power supply module 110 of the device 100a for integrated charging becomes a charging control entity of the battery cell 210 rather than that the charging module 410 becomes the charging control entity of the battery cell 210.

As a result, because heating by the charging module 410 may be prevented as the charging module 410 is not the charging control entity any longer, an increase in temperature of the battery cell 210 of the second electronic device 400 may be prevented.

In this case, the charging power supplied to the battery cell 210 by the charging power supply module 110 of the device 100a for integrated charging may be determined by the following process as described above. First of all, the charging device controller 130 may recognize the information about the supplied constant power and the constant power supply accumulation time and may determine a charging specification range of the battery cell 210 of the second electronic device 400 based on the recognized result.

As an embodiment, the device 100a for integrated charging may convert and supply charging power based on the charging specification information, thus having a feature capable of stably supplying power to the battery device 200 or the first electronic device 300, which does not have a transformation function.

As an embodiment, the controller 111 may adjust a voltage and current value of second power based on the monitored result.

A description will be given in detail of a method for integrated charging according to another embodiment by the system 10 for integrated charging with reference to FIG. 10.

In operation S210, the charging device controller 130 may detect a connection between a power supply target device 200, 300, 400, or 500 and an input/output terminal.

In this case, the input/output terminal may refer to the first input/output terminal 150 of the device 100a for integrated charging.

For a connection with the first input/output terminal 150, it is preferable than the power supply target device 200, 300, 400, or 500 includes a second input/output terminal 250 and the second input/output terminal 250 is configured with a USB-C type terminal. However, as described above, the terminal is not limited to the USB-C type. Because the terminal is able to be connected by applying components such as a gender, various embodiments are applicable.

In operation S230, the charging device controller 130 may determine whether to supply constant power or charging power to the power supply target device 200, 300, 400, or 500 based on the result of communicating with the power supply target device 200, 300, 400, or 500.

When it is detected that the device 100a for integrated charging and the power supply target device 200, 300, 400, or 500 are connected with each other, the charging device controller 130 may first communicate with the power supply target device 200, 300, 400, or 500 and may determine whether the power supply target device 200, 300, 400, or 500 needs constant power or charging power.

### Constant Power Supply

A description will be given of the case where the device 100a for integrated charging supplies constant power with reference to FIG. 10.

In operation S310, the charging device controller 130 may determine a specification of supply power for being supplied to the power supply target device 400 or 500 based on the result of negotiations with the power supply target device 400 or 500.

When the constant power is supplied, because the charging module 410 becomes a charging control entity, a constant power supply module 120 may receive a specification of supply power by means of negotiation from the power supply target device 400 or 500 including the charging module 410.

In operation S330, the constant power supply module 120 may control to convert supply power based on the determined specification of supply power.

### Charging Power Supply

A description will be given of the case where the device 100a for integrated charging supplies charging power with reference to FIG. 11.

In operation S410, the controller 111 may receive charging specification information of the battery device 200 from the memory 220 in the battery device 200.

In operation S430, the controller 111 may determine a specification of supply power based on the charging specification information.

In operation S450, the controller 111 may control the conversion unit 113 such that power is supplied according to a charging specification range and a charging type.

As an embodiment, when the electronic device 300 is the battery device 200, the controller 111 may determine a specification of second power for being supplied to the battery device 200 based on the communication result and may control the conversion unit 113 based on the determine charging specification range and the determined charging type.

As an embodiment, the controller 111 may monitor information about a state of charge of the power supply target device 200 or 300 during a predetermined time after supplying power to the power supply target device 200 or 300 and may adjust a specification of power supplied to the power supply target device 200 or 300 based on the result of monitoring the information about the state of charge.

In this case, the specification of the supplied power may refer to voltage supplied from the device 100a for integrated charging to the power supply target device 200 or 300, a current value, a range, and the like.

As an embodiment, when the power supply target device 200 or 300 is the battery device 200, the controller 111 may operate the monitoring unit 114 and may determine a monitoring level for the battery based on the determined specification of the supply power.

For example, as the charging specification range among second power specifications is narrower, the controller 111 may determine a higher monitoring level. As the charging type is faster, the controller 111 may determine a higher monitoring level.

For such a configuration, reference values of a plurality of battery monitoring levels may be stored in the memory. When the specification of charging power is determined, the controller 111 may determine a monitoring level for the battery based on the determined specification of the charging power.

For example, the controller 111 may operate the monitoring unit 114 depending on the determined monitoring level to monitor the battery of the power supply target device 200 or 300. When an abnormal state is detected, the controller 111 may adjust the specification of supply power. In detail, the controller 111 may change a charging type or may stop charging the battery (e.g., change from fast charging to normal charging).

As an embodiment, the controller 111 may monitor information about a state of charge of the power supply target device 200 or 300 during a predetermined time after supplying charging power to the power supply target device 200 or 300 and may compare the information about the state of charge with the communication result to determine a current specification of the battery of the power supply target device 200 or 300.

The controller 111 may adjust a specification of charging power for the power supply target device 200 or 300 based on the determined current specification of the battery cell 210.

The specification of the second power for the battery of the power supply target device 200 or 300, which is determined by the controller 111, may include a full charge capacity, an amount of current charge, or the like.

In this case, the full charge capacity may refer to a battery capacity (e.g., mWh) capable of being maximally charged in the current state and may refer to a maximum capacity which is reduced by being actually used from a maximum design capacity.

The charging specification may include a charging specification range, a charging type, or the like.

Referring to FIG. 7, when the device 100a for integrated charging and the second electronic device 400 are connected with each other, the device 100a for integrated charging may supply constant power to charge the second electronic device 400 and the charging module 410 of the second electronic device 400 may control charging of the battery cell 210 to perform monitoring.

As the charging module 410 operates, a processor (not shown) of the second electronic device 400 previously allocates a share for battery charge. Thus, a load occurs in the processor (not shown) and heating occurs in the processor (not shown). Particularly, when the second electronic device 400 is in use, such a phenomenon is getting worse.

For the second electronic device 400, the charging device controller 130 in the system 10a for integrated charging according to an embodiment of the inventive concept may determine any one of the charging power supply module 110 of the device 100a for integrated charging and the charging module 410 of the second electronic device 400 as a charging control entity of the battery cell 210 based on at least one of performance of the processor of the second electronic device 400 and information (e.g., temperature or the like) about a state of charge.

For example, when it is determined that there is a possibility that an overload may occur in the second electronic device 400, the charging device controller 130 may determine the charging power supply module 110 of the device 100a for integrated charging as a charging control entity of the battery cell 210.

As an embodiment, when the temperature of the battery cell 210 is greater than or equal to a predetermined temperature based on the monitored result, the charging device controller 130 may determine the charging power supply module 110 of the device 100a for integrated charging as a charging control entity of the battery cell 210.

As an embodiment, when the second electronic device 400 is currently in use based on the monitored result, the charging device controller 130 may determine the charging power supply module 110 of the device 100a for integrated charging as a charging control entity of the battery cell 210.

In a terminal device such as a smartphone in an existing technology, a processor (not shown) of the terminal device is responsible for functions of controlling charging of the battery cell 210 and detecting a state of charge, the case where an overload occurs and the temperature of the terminal device is excessively increased frequently occurs.

However, when it is determined that there is a possibility that an overload may occur in the processor (not shown) of the second electronic device 400, the device 100a for integrated charging may determine the charging power supply module 110 of the device 100a for integrated charging as a charging control entity of the battery cell 210, thus addressing such a problem.

When using the device 100a for integrated charging according to an embodiment of the inventive concept, the second electronic device 400 including the battery cell 210 excludes a component which is responsible for charging the battery in an existing technology or reducing a size of an existing processor, thus increasing the space efficiency of the electronic product.

The above-mentioned method according to an embodiment of the inventive concept may be combined with a server which is hardware and may be stored in a medium to be implemented as a program (or application) to be executed.

For the computer to read the program and execute the methods implemented with the program, the above-mentioned program may include a code coded into a computer language such as C, C++, Java, or a machine language readable through a device interface of the computer by a processor (CPU) of the computer. Such a code may include a functional code associated with a function and the like defining functions necessary for executing the methods and may include a control code associated with an execution procedure necessary for the processor of the computer to execute the functions according to a procedure. Further, such a code may further include a code associated with memory reference about whether additional information or media necessary for the processor of the computer to execute the functions is referred at any location (address number) of an internal or external memory of the computer. Further, if it is necessary for the processor of the computer to communicate with any computer or server located in a remote place to execute the functions, the code may further include a communication related code about how communication is performed with any computer or server located in a remote place using a communication module of the computer and whether to transmit and receive any information or media upon communication.

The medium may refer to a device-readable medium which stores data on a semipermanent basis rather than a medium, such as a register, a cache, or a memory, which stores data during a short moment. The medium may refer to a device-readable medium which stores data on a semipermanent basis rather than a medium, such as a register, a cache, or a memory, which stores data during a short moment. In other words, the program may be stored in various storage media on various servers accessible by the computer or various storage media on the computer of the user. Further, the medium may be distributed to a computer system connected over a network and may store a computer-readable code on a distributed basis.

Steps of the method or algorithm described in connection with an embodiment of the present disclosure may be directly implemented in hardware, may be implemented with a software module executed by hardware, or may be implemented by a combination of the hardware and the software module. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or a computer-readable recording medium well known in the art to which the inventive concept pertains.

Embodiments of the inventive concept provide a system for integrated charging including a charging device capable of charging battery devices, each of which has a different charging specification.

Furthermore, embodiments of the inventive concept may receive information about a rated voltage and a rated current of a battery cell from a circuit module in a battery device, when connected with the battery device, and may determine a charging specification range and a charging type of the battery device based on the received information.

Furthermore, embodiments of the inventive concept may determine whether to supply constant power or charging power based on the result of communicating with a power supply target device, when connected with the power supply target device, and may control a conversion unit depending on the determined result to supply voltage.

The effects of the inventive concept are not limited to the above-described effects and other effects which are not described herein will become apparent to those skilled in the art from the following description.

Although an embodiment of the inventive concept are described with reference to the accompanying drawings, it will be understood by those skilled in the art to which the inventive concept pertains that the inventive concept can be carried out in other detailed forms without changing the scope and spirit or the essential features of the inventive concept. Therefore, the embodiments described above are provided by way of example in all aspects, and should be construed not to be restrictive.

What is claimed is:

1. A system for integrated charging, the system comprising:
a charging device; and
a battery device,
wherein the battery device includes:
a battery cell;
a first memory configured to store charging specification information about charging power required in the battery cell; and
a first input/output terminal, and
wherein the charging device includes:
a power supply unit configured to receive power;
at least one second input/output terminal connected with the battery device;
a conversion unit configured to convert the power into an output corresponding to the charging specification information; and
a controller configured to receive the charging specification information through the at least one second input/output terminal, when connected with the battery device, control to convert the power, based on the received charging specification information, and control such that the converted output is supplied to the battery device through the at least one second input/output terminal.

2. The system of claim 1, wherein the charging device is a charging control entity of the battery cell,
wherein the battery device further includes:
a monitoring unit configured to monitor information about a state of charge of the battery cell through the at least one second input/output terminal, while the converted output is supplied to the battery device, and
wherein the battery cell adjusts a charging specification for the battery device based on the result of monitoring the information about the state of charge.

3. The system of claim 1, wherein the battery device further includes a communication negotiation chip for communication between the battery device and the charging device, and
wherein the first memory, the communication negotiation chip, and the first input/output terminal makes up a standardization module.

4. The system of claim 1, wherein each of the first input/output terminal and the second input/output terminal is a USB-C type terminal.

5. The system of claim 1, wherein a removable battery and an embedded battery in an electronic device are applicable to the battery device, and
wherein the charging device converts and supplies first power into second power based on the charging specification information, such that it is possible to supply power to the battery device which does not have a transformation function.

6. A system for integrated charging, the system comprising:
a power supply unit configured to receive first power;
at least one type of input/output terminal connected with a power supply target device;
a conversion unit configured to convert the first power into second power for being supplied to the power supply target device; and
a charging device controller configured to determine whether to supply constant power or charging power to the power supply target device based on the result of communicating with the power supply target device and control the conversion unit depending on the determined result, when the power supply target device is connected with the at least one type of input/output terminal,
wherein the charging device controller receives charging specification information from a first memory included in a battery device in the power supply target device, when it is determined to supply the charging power to the power supply target device, determines second power for being supplied to the battery device based on the received charging specification information, controls the conversion unit to convert the first power into the determined second power, determines the second power for the power supply target device based on the result of negotiations with the power supply target device, when it is determined to supply the constant power to the power supply target device, and control to supply the constant power to the power supply target device using the determined second power.

7. The system of claim 6, wherein the controller determines a charging specification range of a battery and a charging type including fast charging or normal charging based on the result of communicating with the power supply target device and controls the conversion unit based on the determined charging specification range and the determined charging type, when the power supply target device is the battery device.

8. The system of claim 7, wherein the controller monitors information about a state of charge of the battery device during a predetermined time after supplying charging power to the battery device and adjusts a specification of the second power based on the result of monitoring the information about the state of charge.

9. The system of claim 7, wherein the controller operates a monitoring unit and determines a monitoring level for the battery device, based on a specification of the determined second power, when the power supply target device is the battery device.

10. The system of claim 6, wherein the controller monitors information about a state of charge of the power supply target device during a predetermined time after supplying charging power to the power supply target device, compares the information about the state of charge with the result of communicating with the power supply target device to determine a current battery specification of the power supply target device, and adjusts a charging specification for the power supply target device based on the determined current battery specification.

11. The system of claim 6, wherein the controller determines any one of the power supply target device and a charging device as a charging control entity of the power supply target device based on at least one of performance of a processor of the power supply target device and information about a state of charge, after supplying the constant power to the power supply target device.

12. The system of claim 11, wherein the controller determines the charging device as a charging control entity of a battery cell included in the power supply target device, when a temperature of the battery cell is greater than or equal to a predetermined temperature based on a monitored result.
